(19) United States
(12) Patent Application Publication
(10) Pub. No.: US 2019/0254453 A1
(43) Pub. Date: Aug. 22, 2019

(54) COOLING AND HEATING TRAY FOR GASTRONOMY CONTAINERS

(71) Applicant: JOSEF HÖLLER GMBH, Amstetten (AT)

(72) Inventors: Josef HÖLLER, Neufurth (AT); Joachim HÖLLER, Zeillern (AT)

(21) Appl. No.: 16/345,843

(22) PCT Filed: Oct. 30, 2017
(86) PCT No.: PCT/AT2017/060290

§ 371 Date: Apr. 29, 2019

(30) Foreign Application Priority Data
Oct. 31, 2016 (AT) A50997/2016

(51) Int. Cl. A47G 23/04; A47J 36/24; F25D 31/00

(52) U.S. Cl. CPC A47G 23/04; A47F 10/06; F25D 31/005; A47J 36/2483

(57) ABSTRACT

The cooling and heating tray (11) for gastronomy containers has a base (12) and side walls (13, 14, 15), wherein a heating device and a cooling device are provided for optional operation as a heating tray or as a cooling tray, and wherein the heating device heats the base (12). According to the invention, both the base (12) and the side walls (13, 14, 15) consist of stainless steel, and the base (12) is fixed at a number of locations, preferably by means of threaded bolts (16) welded to the base (12), to a sandwich panel (20), preferably consisting of a layer of stainless steel (21), a layer of aluminium (22) and a further layer of stainless steel (23). The cooling device cools both the side walls (13, 14, 15) and the base (12).

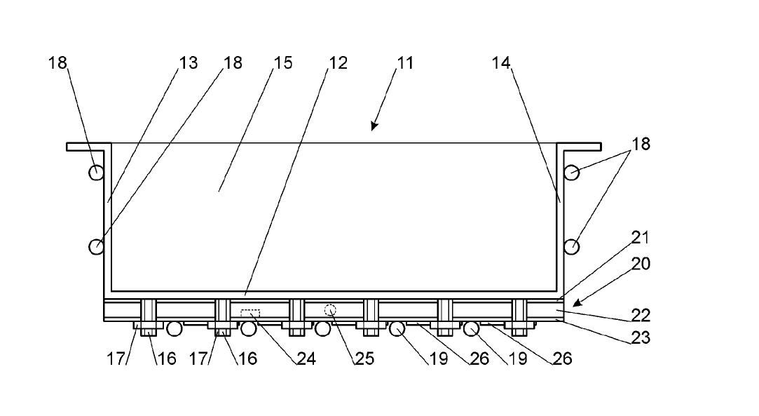

### TECHNICAL FIELD

The present invention relates to a cooling and heating tray for gastronomy containers, which has a base and side walls, wherein a heating device and a cooling device are provided for optional operation as a heating tray or as a cooling tray, and wherein the heating device heats the base,

### PRIOR ART

Cooling trays and heating trays are widespread in restaurants for serving buffets. These are trays of standard sizes, into which what are referred to as gastronomy containers which likewise have standard sizes can be suspended. Generally, each tray can only carry out one function, i.e. either cooling or heating, but combined cooling and heating trays are also known, see, for example, patcit0001:DE 202011050444 U - - - .

Both in the case of cooling trays and in the case of heating trays, two different operating modes are possible; either dry or with a water bath (bain marie). In the bain marie operating mode, the tray, of course, has to be absolutely watertight, specifically for many years; it would be highly unpleasant were the restaurant guests to step into a puddle of water when they want to take food.

In dry operation, the heating tray should be capable of generating temperatures of pp to 140° C. in order to keep the food in the gastronomy container at the desired temperature. If, on the other hand, a cooling tray is also intended to be suitable for dispensing ice cream, it has to be able to reach temperatures of significantly below 0° C.

According to the abovementioned patcit0002:DE 202011050444 U - - - , the heating device is in the form of a Ceran glass panel which forms the base of the tray. Although high temperatures can be reached with Ceran glass panels, the bain marie operating mode is not possible. According to this document, the cooling device is in the form of a cooling pipe which exclusively cools the side walls. However, temperatures significantly below 0° C. cannot be reached therewith.

Known heating trays for the bain marie operating mode are frequently formed from chromium steel. If said heating trays are operated dry and heated to temperatures of around 140° C., they warp and thereby become unusable because the gastronomy containers can then no longer be suspended.

### SUMMARY OF THE INVENTION

It is an object of the present invention to provide a cooling and heating tray which can be operated both in a dry operating mode and in the bain marie operating mode and which is also suitable for dispensing ice cream.

According to the invention, this object is achieved by a cooling and heating tray of the type mentioned at the beginning in that both the base and the side wails are composed of stainless steel, in that the base is fixedly connected at a plurality of points to a sandwich panel, preferably consisting of a layer of stainless steel a layer of aluminum and a layer of stainless steel, and in that the cooling device cools both the side walls and the base.

A preferred stainless steel is chromium Steel. The term chromium steel is not intended to exclude other alloying constituents; i.e. it comprises in particular chromium nickel steel.

According to the invention, the cooling and heating tray is therefore produced from stainless steel (chromium steel)—as is customary in the case of bain marie heating trays. This is possible by means of bending and welding, and therefore the water tightness over decades is not an issue. As mentioned, however, such trays have a tendency to warp when they are greatly heated. For this reason, the base is stiffened with a sandwich panel. For weight reasons, the middle layer is composed of aluminum, and at the top and bottom a respective layer of stainless steel (chromium steel) is provided. As a result, the sandwich panel obtains very high flexural rigidity with a relatively low weight and good heat conductivity. The sandwich panel is fixedly connected, for example screwed, to the base at numerous points, and therefore the base cannot warp.

Since, in contrast to patcit0003:DE 202011050444 U - - - , the base is not composed of glass, there is furthermore the possibility of also cooling the base via cooling pipes, and therefore temperatures of significantly below 0° C. can be reached.

The connection between the base and the sandwich panel expediently takes place in such a manner that a plurality of screw bolts are welded onto the base and are used to screw the sandwich panel to the base. As a result, a fixed connection between base and sandwich panel can be ensured at numerous points.

Preferably, the cooling device consists of at least one cooling pipe, which cooling pipe or which cooling pipes lies or lie fixedly against the lower side of the sandwich panel and against the side walls. As an alternative thereto, a cooling duct can be incorporated into the middle layer of the sandwich panel, or a cooling pipe can be cast therein,

The heating device preferably consists of at least one silicone surface heater which lies against the lower side of the sandwich panel.

### BRIEF DESCRIPTION OF THE DRAWINGS

The present invention will be explained in more detail with reference to the attached drawing. The single FIGURE shows a cooling and heating tray according to the invention in section.

### BEST WAY FOR IMPLEMENTING THE INVENTION

The cooling and heating tray denoted overall by 11 has a base 12 and side walls 13, 14, 15. (The fourth side wall is located in front of the plane of the drawing.) As is seen, the base 12 and the side walls 13, 14 can be bent from a piece of chromium steel. The side wall 15 and the fourth, invisible side wall, likewise made from chromium steel, are welded on. This results overall in a tray which is watertight for many years.

Screw bolts 16 are welded to the base 12 and hold a sandwich panel 20 by means of nuts 17. The sandwich panel 20 consists of a layer of chromium steel 21, a layer of aluminum 22 and a further layer of chromium steel 23. The layers 21-23 are fixedly connected to one another by adhesive bonding or pressing. The sandwich panel 20 is highly flexurally rigid because of the two spaced-apart layers of chromium steel 21 and 23, but is nevertheless not too heavy because of the use of aluminum as intermediate layer. Overall, the flexurally rigid sandwich panel 20, which is connected to the base 12 by numerous screw bolts 16, protects the entire cooling and heating tray 11 from warping due to high heat.

Cooling pipes 18 are attached to the side walls 13, 14 (likewise to the two other side walls, but this is not visible in the FIGURE). Various cooling possibilities are possible for the base 12. Cooling pipes 19 can be attached at the bottom to the sandwich panel 20, but cooling ducts can also be milled into the layer of aluminum 22, as indicated by dashed lines at 24, or cooling pipes can be cast therein, as indicated by dashed lines at 25.

If cooling pipes 19 are present, silicone heating mats 26 are then attached therebetween; otherwise, an extensive silicone heating mat can be attached.

A refrigerant flows through the cooling pipes 18, 19, 25 or cooling ducts 24. The cooling of the refrigerant can take place centrally, but it is also possible to attach a cooling unit directly below the cooling and heating tray 11, as is known from patcit0004DE 202011050444 U - - - , such that isolated operation is possible.

The cooling pipes 18, 19 are composed of copper. They are fastened by sheet-metal parts to the side walls 13, 14 and are adhesively bonded by aluminum strips to the base 12. They are surrounded as customary by insulating material, the insulating material itself is protected by cover plates. The cooling pipes 18, 19 are thereby additionally fixed or pressed on.

Four functions are made possible by the cooling and heating tray according to the invention:

cooling (dry)

cooling by means of a water bath

heating by means of a water bath

heating with dry heat

Temperatures of −5° C. to +140° C. can be achieved.

1. A cooling and heating tray (11) for gastronomy containers, which has a base (12) and side walls (13, 14, 15), wherein a heating device and a cooling device are provided for option& operation as a heating tray or as a cooling tray, and wherein the heating device heats the base (12), characterized in that both the base (12) and the side walls (13, 14, 15) are composed of stainless steel, in that the base (12) is fixedly connected at a plurality of points to a sandwich panel (20), preferably consisting of a layer of stainless steel a layer of aluminum (22) and a layer of stainless steel (23), and in that the cooling device cools both the side walls (13, 14, 15) and the base (12).

2. The cooling and heating tray as claimed in claim 1, characterized in that a plurality of screw bolts (16) are welded onto the base (12) and are used to screw the sandwich panel (20) to the base (12).

3. The cooling and heating tray as claimed in claim 1 or 2, characterized in that the cooling device consists of at least one cooling pipe (18, 19), which cooling pipe or which cooling pipes lies or lie fixedly against the lower side of the sandwich panel (20) and against the side walls (13, 14, 15).

4. The cooling and heating tray as claimed in claim 1 or 2, characterized in that a cooling duct (24) is incorporated, or a cooling pipe (25) cast, into the middle layer (22) of the sandwich panel (20), and in that a cooling pipe (18) lies fixedly against the side walls.

5. The cooling and heating tray as claimed in one of claims 1 to 4, characterized in that the heating device consists of at least one silicone surface heater (26) which lies against the lower side of the sandwich panel (20).
